(19) United States
(12) Patent Application Publication
(10) Pub. No.: US 2016/0138539 A1
(43) Pub. Date: May 19, 2016

(54) SYSTEM AND METHOD FOR DELIVERING AN ADDITIVE TO FUEL IN A FUEL TANK

(71) Applicant: MTD Products Inc, Valley City, OH (US)

(72) Inventor: Darren Bisaro, Chandler, AZ (US)

(21) Appl. No.: 14/944,611

(22) Filed: Nov. 18, 2015

Related U.S. Application Data
(60) Provisional application No. 62/081,085, filed on Nov. 18, 2014.

(51) Int. Cl. F02M 43/00; F02M 37/00

(52) U.S. Cl. CPC F02M 43/00; F02M 37/0047

(57) ABSTRACT

A fuel additive delivery system that includes a fuel tank with an integrated fuel additive delivery unit. A fuel additive is located within the fuel additive delivery unit and is in continual fluid communication with fuel within the fuel tank to allow the fuel additive to intermix with the fuel to condition the fuel in the fuel tank.

### CROSS-REFERENCE TO RELATED APPLICATION

This application claims the priority benefit of U.S. Provisional Patent Application Ser. No. 62/081,085 filed Nov. 18, 2014.

### FIELD OF THE INVENTION

The present invention is directed to fuel-powered tools, and more particularly, to a system and method of delivering a fuel additive to the fuel in such tools.

### BACKGROUND OF THE INVENTION

Owners and operators of fuel-powered tools, particularly those used in outdoor or lawn maintenance applications, typically do not use the tools on a continuous, year-round basis. Often, once the season changes and the tools are no longer able to be used. As a consequence, the owners often store these tools in a garage, shed, or other building until the next season in which they can be used. However, when storing these tools that use fuel, such as gasoline or the like, the tools are stored such that the fuel tank is full or at least partially full of fuel.

When fuel is stored in a tool (or stored for extended periods, in general), the fuel begins to oxidize, and this oxidation forms solid particles within the fuel. More of these solid oxidized particles are formed when the fuel tank is less than half-full due to the increased oxidizing agents that results from more air being present in the fuel tank. Fuel-powered tool manufacturers typically suggest and/or recommend adding a fuel additive, such as a fuel additive, to the fuel to prevent formation of these solid oxidation particles. Fuel additives are even recommended during the seasons when the tool is being used.

These solid oxidation particles are particularly harmful to the fuel lines and engine components of the tools, because they can cause blockages in the fuel line and/or gum up the engine components. These problems often lead to the tool needing repair or replacement, and can increase warranty claims for the tool manufacturer.

### BRIEF SUMMARY OF THE INVENTION

In one aspect of the present invention, a fuel additive delivery system is provided. The fuel additive delivery system includes a fuel tank defining and interior volume. The fuel additive delivery system also includes a fuel additive delivery unit integrally connected with the fuel tank. A fuel additive is located within the fuel additive delivery unit being in continual fluid communication with fuel in the fuel tank.

In another aspect of the present invention, a fuel additive delivery system is provided. The fuel additive delivery system includes a fuel tank having an upper wall, a lower wall, a plurality of sidewalls extending between the upper and lower walls, and a spout defining an opening extending from the upper wall. The fuel tank defines an interior volume. The fuel additive delivery system also includes a fuel additive delivery unit integrally connected with the lower wall or one of the sidewalls of the fuel tank. A fuel additive is located within the fuel additive delivery unit being in continual fluid communication with fuel in the fuel tank.

Advantages of the present invention will become more apparent to those skilled in the art from the following description of the embodiments of the invention which have been shown and described by way of illustration. As will be realized, the invention is capable of other and different embodiments, and its details are capable of modification in various respects.

### BRIEF DESCRIPTION OF SEVERAL VIEWS OF THE DRAWINGS

These and other features of the present invention, and their advantages, are illustrated specifically in embodiments of the invention now to be described, by way of example, with reference to the accompanying diagrammatic drawings, in which:

FIG. 1 is an exemplary embodiment of a fuel-powered tool;

FIG. 2A is a side cross-sectional view of a fuel additive dispersion system;

FIG. 2B is a top cross-sectional view of the fuel additive dispersion system shown in FIG. 2A;

FIG. 3A is a side cross-sectional view of another embodiment of a fuel additive dispersion system;

FIG. 3B is a top cross-sectional view of the fuel additive dispersion system shown in FIG. 3A;

FIG. 4 is a side cross-sectional view of another embodiment of a fuel additive dispersion system;

FIG. 5A is side cross-sectional view of another embodiment of a fuel additive dispersion system;

FIG. 5B is a front cross-sectional view of the fuel additive dispersion system shown in FIG. 5A;

FIG. 5C is a front cross-sectional view of another embodiment of the fuel additive dispersion system shown in FIG. 5A.

It should be noted that all the drawings are diagrammatic and not drawn to scale. Relative dimensions and proportions of parts of these figures have been shown exaggerated or reduced in size for the sake of clarity and convenience in the drawings. The same reference numbers are generally used to refer to corresponding or similar features in the different embodiments. Accordingly, the drawing(s) and description are to be regarded as illustrative in nature and not as restrictive.

### DETAILED DESCRIPTION OF THE PREFERRED EMBODIMENT

Fuel-powered tools, especially those used in outdoor and/or lawn maintenance applications, are often stored in garages, sheds, or other buildings for extended periods of time without use, particularly during the “off-season.” For example, snow throwers that are used during the winter are usually stored unused during the spring, summer, and fall only to be brought out and used only during the winter. Similarly, blowers, lawn mowers, string trimmers, and the like are typically used during spring, summer, and fall for lawn and property maintenance, but are then stored unused during the winter months. Fuel-powered tool manufacturers typically recommend that the operator regularly add a fuel additive, such as a stabilizer or the like, to the fuel to aid in maximizing the efficiency and extend the life of the engine. Unfortunately, some owners may not be aware of this recommendation or may forget to regularly include the fuel additive when the fuel tank is refilled. Also, the owner may not add the proper amount of fuel additive.

During the long-term storage of these tools, owners often leave the fuel tank at least partially filled with fuel. The fuel in the fuel tank immediately begins to oxidize, and over an extended period of time, this oxidation results in solid particles that can be introduced into the fuel line, carburetor, and/or the combustion cylinder. These solid particles can cause additional wear-and-tear on the engine of the tools and shorten the life of the engine. The fuel additive delivery unit 18 described below provides for a fuel tank having an integrated device that introduces a fuel additive into the stored fuel to reduce or eliminate the formation of these solid particles, thereby extending the life of the engine on these tools. The fuel additive delivery unit 18 is designed to ensure the proper amount of fuel additive is intermixed with the fuel, without overmixing (causing too much additive to be added to the fuel) or undermixing (causing too little additive to be added to the fuel)

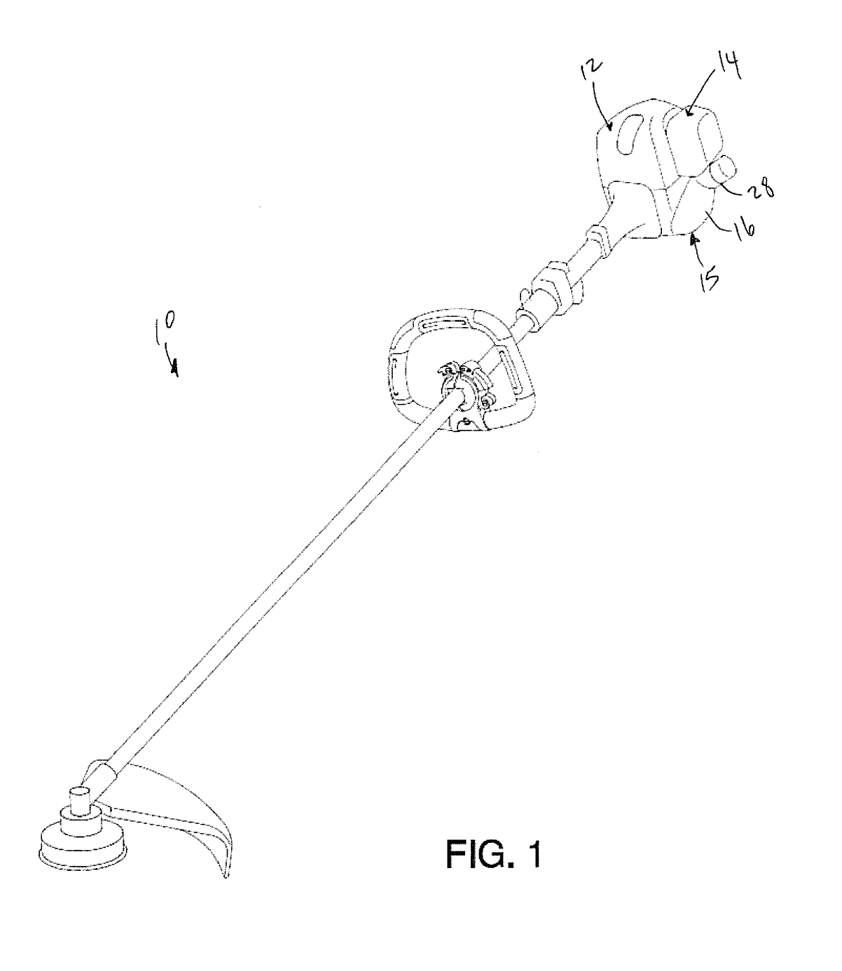

Referring to FIG. 1, an exemplary embodiment of a fuel-powered tool 10 is show as a string trimmer. It should be understood by one having skill in the art that the string trimmer is being shown for an exemplary reference only and the fuel additive delivery system shown and described below can be incorporated with any fuel-power tool, including but not limited to a snow thrower, a walk-behind lawn mower, a garden tractor, a riding mower, a tiller, a hand-held or backpack blower, a hedge trimmer, a chainsaw or polesaw, an edger, a log splitter, or the like. Although the description provided herein will make reference to the fuel additive delivery system being incorporated with a handheld tool, it should be understood by one having ordinary skill in the art that the system may also be incorporated into automobiles, motorcycles, golf carts, generators, or any other fuel-powered device as well as stand-alone fuel storage tanks or cans. The tool 10 includes a housing 12 surrounding a fuel-powered engine 14, which selectively drives the tool 10. The engine 14 includes the fuel additive delivery system 15 which includes a fuel tank 16 that is fluidly connected to the combustion chamber (not shown), and the fuel tank 16 is configured to store the fuel.

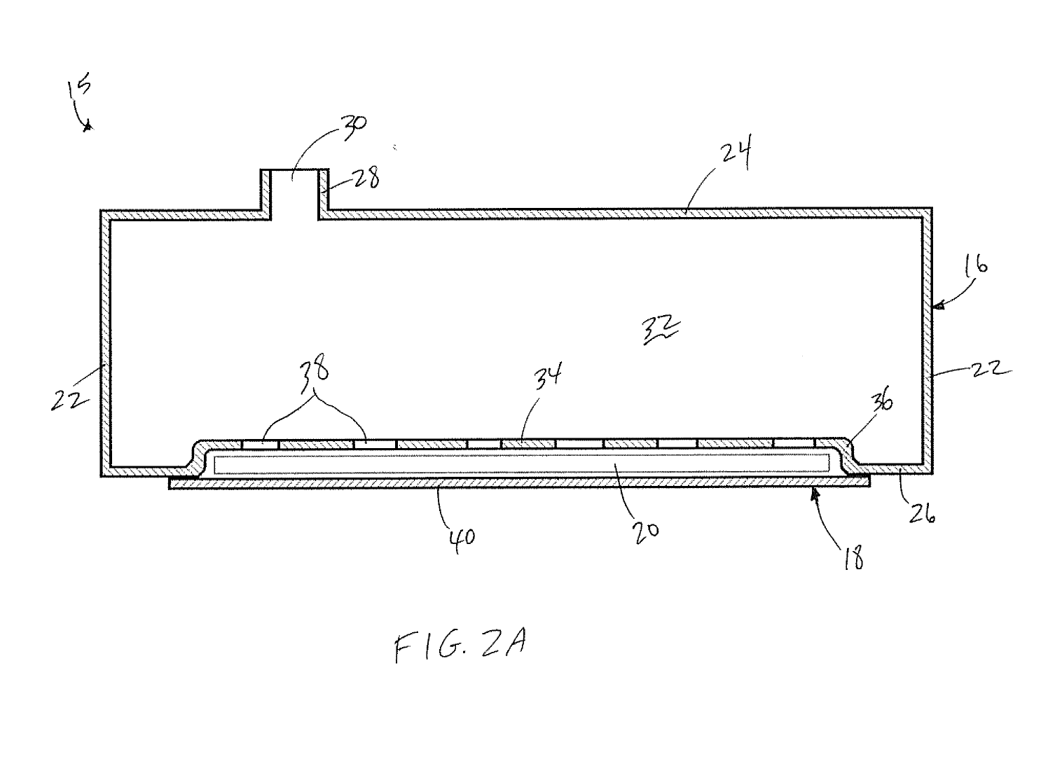

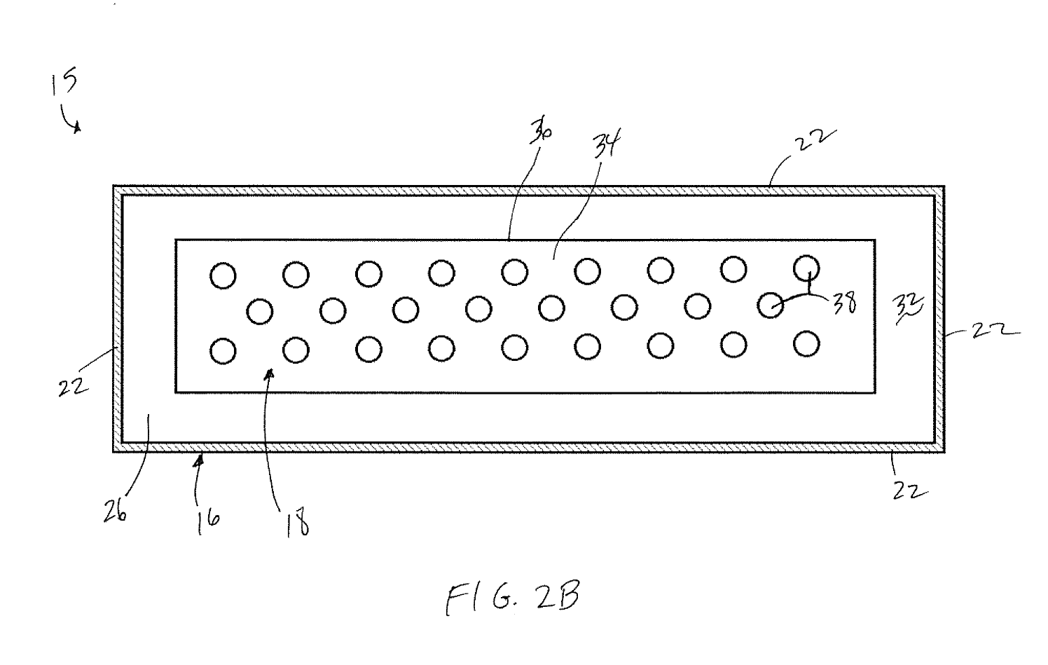

An embodiment of a fuel additive delivery system 15 includes a fuel tank 16 and a fuel additive unit 18, wherein a fuel additive 20 is located within the fuel additive delivery unit 18 and is in continual fluid communication with fuel in the fuel tank 16. The fuel tank is configured to be used in combination with an internal combustion engine, and the integrated fuel additive delivery unit 18 is configured to contain and dispense a fuel additive 20, shown in FIG. 2. The unit 18 is integrally formed with or incorporated with or otherwise integrally attached to or connected to the fuel tank 16. In the illustrated embodiment, a portion of the unit 18 is integrally formed with fuel tank 16, thereby forming a large portion of the lower wall thereof. The remaining structure of the unit 18 is formed separately and can either be removably attached to the lower wall of the fuel tank 16 or fixedly and permanently attached to the lower wall. The fuel additive delivery unit 18 is configured to be in continuous fluid contact with the fuel stored in the fuel tank 16 so as to allow the fuel additive 20 contained in the unit 18 to be introduced into or otherwise mixed with the fuel. The fuel additive delivery unit 18 is configured to form a portion of the fuel tank 16, and while components of the unit 18 may be removed or replaced, at least a portion of the unit 18 remains physically incorporated with the fuel tank 16.

As shown in FIGS. 2A-2B, the fuel tank 16 of the fuel additive delivery system 15 has a plurality of sidewalls 22, and upper wall 24, and a lower wall 26 integrally connected together. A spout 28 extends from one of the sidewalls 22 or the upper wall 24, thereby forming an opening 30 to allow fuel to be introduced or extracted from the fuel tank 16 through the opening 30 in the spout 28. It should be understand by one having ordinary skill in the art that the sidewalls 22 can be formed together to form any shape or size, but the illustrated fuel tank 16 has a generally rectangular shape. It should be understood by one having ordinary skill in the art that other embodiments of the fuel tank may have continuous sidewalls or may otherwise be irregularly shaped such that it may be difficult to define particular walls that are separate from the others; as such, the spout 28 extends generally from a wall of the fuel tank 16. Any reference to sidewalls or upper and lower walls should be understood to indicate generally any wall or portion of a wall of a fuel tank 16. The opening 30 of the spout 28 is in fluid communication with the interior volume 32 defined by the walls of the fuel tank 16.

In the embodiment illustrated in FIGS. 2A-2B, the fuel additive delivery unit 18 of the fuel additive delivery system 15 is integrally connected to, or integrally formed with the lower wall 26. The integration of the unit 18 with the lower wall 26 results in a lower wall 26 having a non-planar shape. It should be understood by one having ordinary skill in the art that the lower wall 26 of the fuel tank 16 can be formed as a planar or flat members in which the unit 18 extends outwardly therefrom. In the illustrated embodiment, the lower wall 26 of the fuel tank 16 includes a raised portion 34 that extends inwardly into the interior volume 32 from the lower wall 26 by way of a transition portion 36. In another embodiment, the raised portion 34 extends outwardly from the lower wall 26. In the illustrated embodiment, the raised portion 34 includes a plurality of apertures 38 formed through the thickness thereof. The apertures 38 provide a fluid connection between the fuel additive 20 located in the unit 18 with the fuel within the interior volume 32.

The apertures 38 formed in the raised portion 34 of the lower wall 26 are sized and shaped to allow continuous fluid contact between the fuel stored in the interior volume 32 and the fuel additive 20 that is located within the fuel additive dispensing unit 18, as shown in FIGS. 2A-2B. The apertures 30 are configured to allow enough of the fuel additive 20 to be intermixed with the fuel during storage to provide a ratio of fuel additive to properly condition the fuel as it is stored for long periods of time and/or improve the characteristics of the fuel during use by the engine. In the illustrated embodiment the apertures 38 are formed as circular holes in the raised portion 34. Each of the circular apertures 38 are formed of the same size and shape and are oriented in a staggered pattern. It should be understood by one having ordinary skill in the art that the size, shape, and pattern of the apertures 38 in FIG. 2B are merely representative of one exemplary embodiment, and the size, shape, and pattern of the apertures 38 of the unit 18 that fluidly connect the unit 18 and the fuel tank 16 can vary between embodiments as well as within the same embodiment. For example, in an embodiment, the apertures 38 can be formed as different shapes. In another embodiment, the apertures 38 can be formed of different sizes of the same shape. It should also be understood by one having ordinary skill in the art that the raised portion 34 may include a single aperture 38 through which the fuel in the interior volume 32 is intermixed with the fuel additive 20 in the unit 18.

In an embodiment, the fuel additive delivery unit 18 also includes a panel 40 attached to the lower wall 26 of the fuel tank 16, as shown in FIG. 2A. The panel 40 is formed separately from the fuel tank 16 and attached thereto to form the fuel additive delivery unit 18 and enclose the fuel additive 20 within the unit 18. In the illustrated embodiment, the panel 40 is fixedly attached to the lower wall 26 of the fuel tank 16 to form a permanent, sealed connection therewith. The permanent connection between the panel 40 and the fuel tank 18 necessitates that the initial amount of fuel additive 20 located within the fuel additive delivery unit 18 to last the entire life of the fuel tank 16 or fuel-powered tool 10. In another embodiment, the panel 40 is configured to be removably (or rotatably) yet sealingly attached to the lower wall 26 of the fuel tank 16 to form the unit 18. The removable panel 40 allows the unit 18 to be opened for removal and/or replacement of the fuel additive 20 within the unit 18.

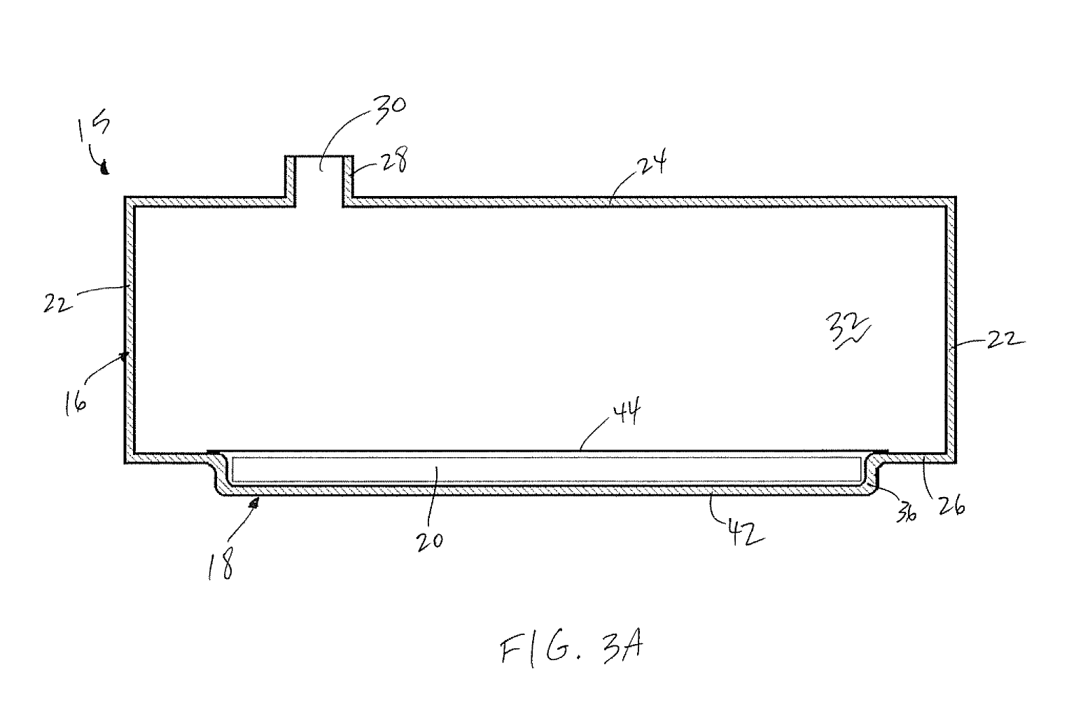

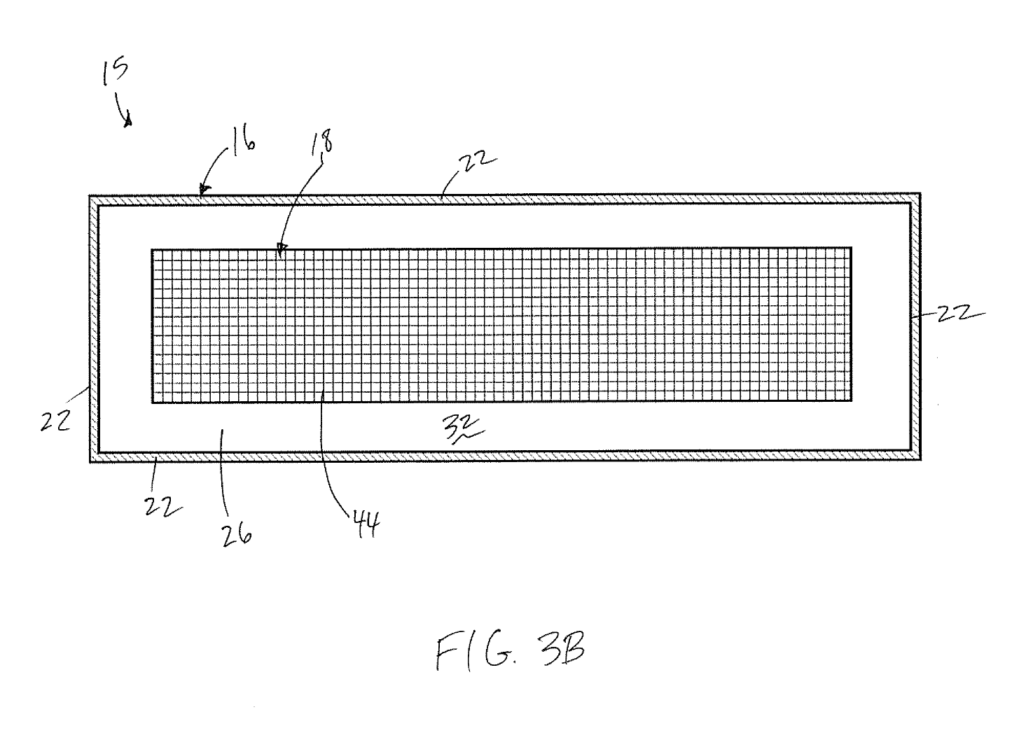

In another embodiment, the fuel additive delivery system 15 includes a fuel tank 16 having an integrated fuel additive delivery unit 18 in which the fuel additive 20 is located within the unit 18, as shown in FIGS. 3A-3B. The fuel tank 16 includes a plurality of sidewalls 22, an upper wall 24, a lower wall 26, and a spout 28 extending from the upper wall 24 to form an opening 30. The walls of the fuel tank 16 define an interior volume 32 therein. The unit 18 extends downwardly from the lower wall 26 of the fuel tank 16, as shown in FIG. 3A. The unit 18 includes a lowered portion 42 that is integrally connected to the lower wall 26 by way of a transition portion 36, which allows the lowered portion 42 to be spaced below the lower wall 26. In the illustrated embodiment, the lower portion 42, transition portion 36, and the lower wall 26 are integrally formed together to form a continuous wall. The fuel additive delivery unit 18 is fluidly connected to the interior volume 32 but is physically separated by a barrier 44 that covers the entire opening into the unit 18. In the illustrated embodiment, the barrier 44 is formed as a meshed member having wires formed perpendicular to each other and providing for a plurality of openings through which fuel within the fuel tank 16 can enter the fuel additive delivery unit 18 and mix with the fuel additive 20. The size of the opening between the unit 18 and the interior volume 32 may be different in different embodiments, and the opening may form a ledge (not shown) that extends from the lower wall 26 over a portion of the unit 18. The barrier 44 can be formed of any material that allows the fuel additive 20 located within the unit 18 to mix with and be dispersed into the fuel within the interior volume 32 of the fuel tank 16. The barrier 44 is configured to allow enough of the fuel additive 20 to be intermixed with the fuel during storage to provide a ratio of fuel additive to properly condition the fuel as it is stored for long periods of time and/or improve the characteristics of the fuel during use by the engine.

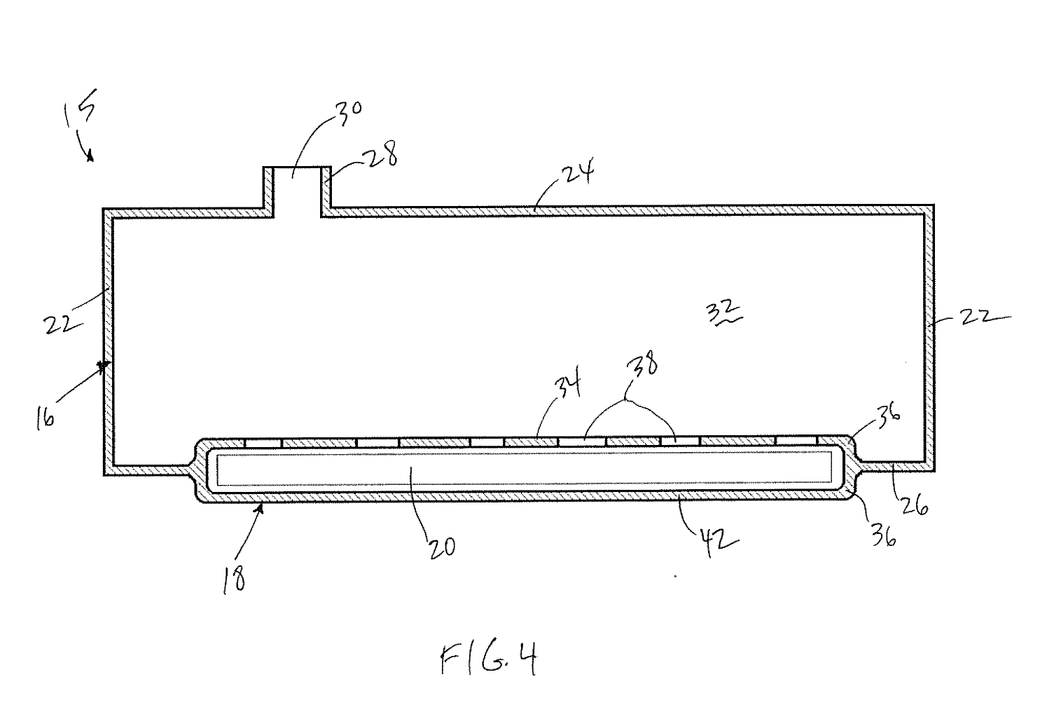

In the embodiments of the fuel additive delivery system 15 shown in FIGS. 2A-2B and 3A-3B, the shell of the fuel tank 16 is formed prior to positioning the fuel additive 20 within the fuel additive delivery unit 18. After adding the fuel additive 20 to the unit 18, the unit 18 is sealed with the panel 40 (FIG. 2A) or the barrier 44 (FIG. 3A). In both embodiments, the panel 40 and barrier 44 may be fixedly attached to the lower wall 26 such that the fuel additive 20 is not replenishable, or the panel 40 and barrier 44 may be releasably connected to the lower wall 26 to allow the fuel additive 20 to be replenishable. In other embodiments, the fuel tank 16 is formed around the fuel additive 20, as shown in FIG. 4.

In the embodiment shown in FIG. 4, the fuel tank 16 of the fuel additive delivery system 15 is formed with an integrated fuel additive delivery unit 18 in which the unit 18 is fully enclosed during the formation of the fuel tank 16. As such, the fuel tank 16 is manufactured such that the fuel additive 20 is fully enclosed during formation of the fuel tank 16 and unit 18. The unit 18 can be formed with a plurality of apertures 38 formed into the raised portion 34 of the lower wall 26 of the fuel tank 16 to allow for intermixing of the fuel within the interior volume 32 and the fuel additive 20 located within the unit 18. The unit 18 is defined by the raised portion 34 and transition portion 36 that extend upwardly into the interior volume 32 from the lower wall 26 as well as the lowered portion 42 and transition portion 26 that extend downwardly away from the interior volume 32. The raised portion 34 includes a plurality of apertures 38 formed therein to allow the fuel additive 20 to be in fluid communication with the fuel within the interior volume 32.

In the above illustrated embodiments, the fuel additive delivery unit 18 of the fuel additive delivery system 15 is positioned at the bottom of the fuel tank 16 such that the fuel additive 20 remains in continuous fluid communication with the fuel within the interior volume 32 to allow continuous delivery of the fuel additive 20 unless the fuel tank 16 is empty. In other embodiments of the fuel additive delivery system 15, the fuel additive delivery unit 18 is formed such that the portion of the fuel additive 20 in mixing communication with the fuel within the fuel tank 16 is dependent upon the level to which the interior volume 32 is filled with fuel.

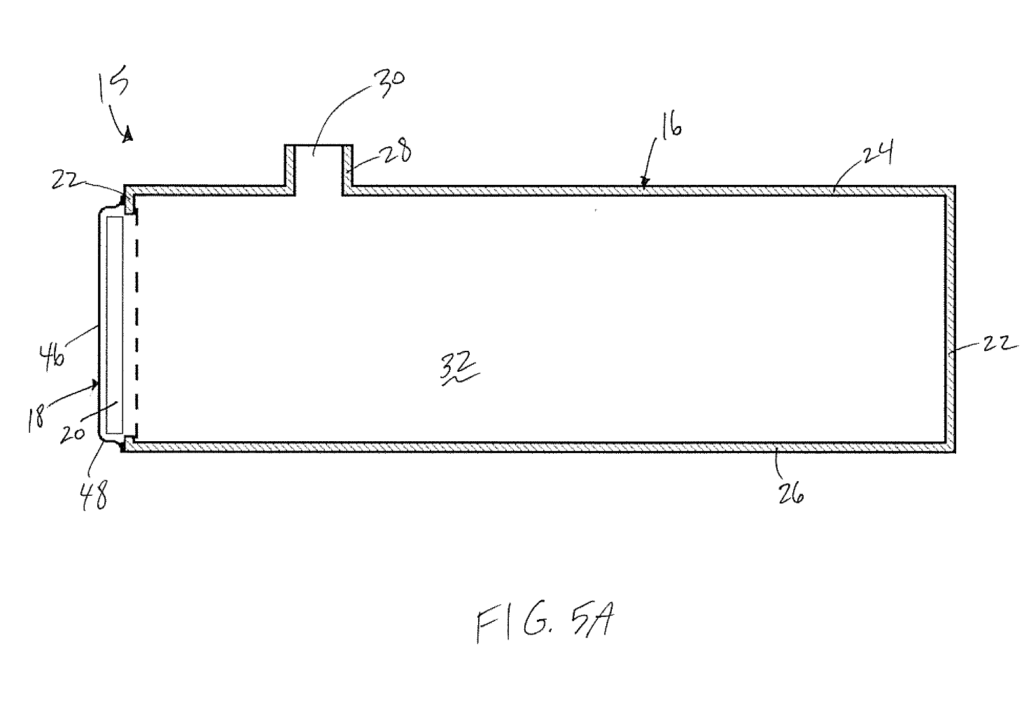

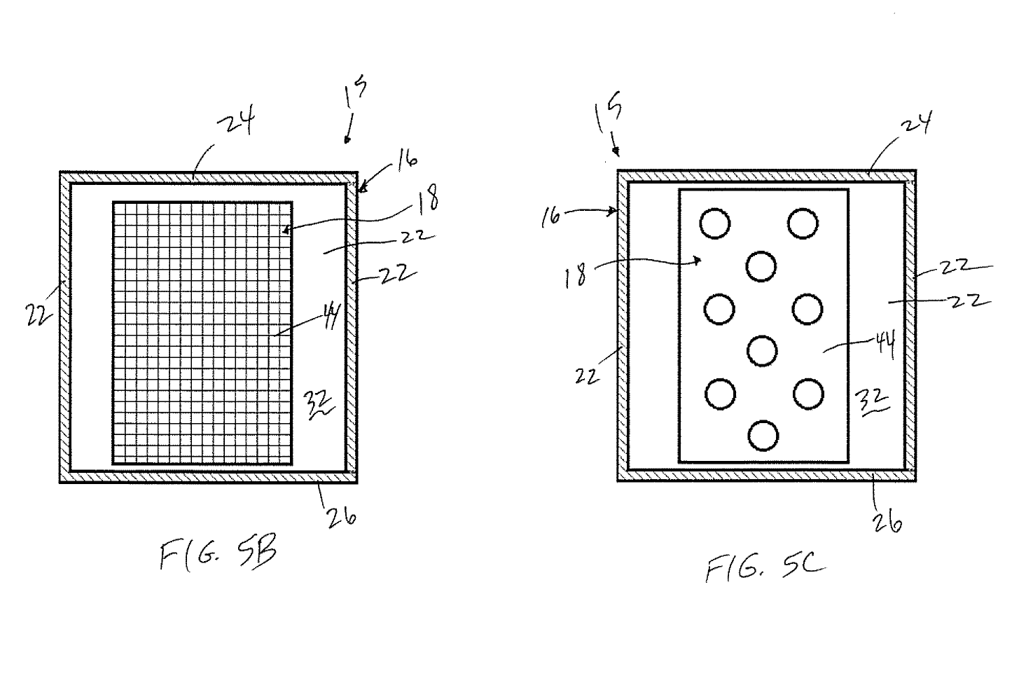

In other embodiments of the fuel additive delivery system 15, illustrated in FIGS. 5A-5C, the fuel additive delivery unit 18 is formed into a sidewall 22 of the fuel tank 16. The fuel tank 16 includes an upper wall 24, a lower wall 26, a plurality of sidewalls 22, a spout 28 extending from the upper wall 24 and forming an opening 30 into the interior volume 32. The unit 18 includes a lateral portion 46 extending laterally from a sidewall 22 and connected to the sidewall 22 by a transition portion 48. The unit 18 includes a barrier 44 covering the opening between the unit 18 and the interior volume 32. The barrier 44 can be formed as a solid member having a plurality of apertures formed therethrough (FIG. 5B) or as a mesh (FIG. 5C). The barrier 44 is fixedly attached to the sidewall 22. Because the fuel additive 20 is oriented substantially vertical, the amount of fuel additive 20 in mixing communication with the fuel within the interior volume 32 depends upon the fill level of the fuel. The more fuel within the interior volume 32 results in more exposure of the fuel additive 20 to the fuel. As the fuel additive 20 is utilized from the lower end, the fuel additive 20 in solid form can slide downwardly so that there always fuel additive 20 at the lower end of the unit 18 to mix with the fuel, as long as the amount of fuel covers the lower end of the unit 18.

It should be understood by one having ordinary skill in the art that the fuel additive 20 can be in full mixing communication with the fuel within the interior volume 32 or be in partial mixing communication therewith. The mixing of the fuel and the additive occurs within the fuel additive delivery unit 18, which allows the fuel to enter, mix with the additive and exit the unit 18 for interspersion with the remaining amount of fuel. Although the fuel additive 20 is illustrated as a solid piece, it should be understood by one having ordinary skill in the art that the fuel additive may also be a liquid, a combination thereof, a gel, a foam, or any other form that allows mixing of the additive with fuel within the fuel tank 16. The fuel additive 20 can be a fuel stabilizers, anti-oxidants, octane boosters, a corrosion inhibitors, anti-knock agents, lead scavengers,

The fuel additive delivery system 15 is configured to comply with all government regulations, including, but not limited to, 40 CFR §§1054, 1060, and 1065.

While preferred embodiments of the present invention have been described, it should be understood that the present invention is not so limited and modifications may be made without departing from the present invention. The scope of the present invention is defined by the appended claims, and all devices, processes, and methods that come within the meaning of the claims, either literally or by equivalence, are intended to be embraced therein.

What is claimed is:

1. A fuel additive delivery system comprising:
a fuel tank defining and interior volume; and
a fuel additive delivery unit integrally connected with said fuel tank, wherein a fuel additive is located within said fuel additive delivery unit being in continual fluid communication with fuel in said fuel tank.

2. The fuel additive delivery system of claim 1, wherein said fuel tank includes at least one sidewall defining an interior volume therewithin and a spout extending from one of said at least one sidewall.

3. The fuel additive delivery system of claim 1, wherein said fuel additive delivery unit is formed about said fuel additive.

4. The fuel additive delivery system of claim 1, wherein said fuel additive is a fuel stabilizer.

5. The fuel additive delivery system of claim 1, wherein said fuel tank includes a lower wall, and at least a portion of said fuel additive delivery unit is integrally formed with said lower wall of said fuel tank.

6. The fuel additive delivery system of claim 1, wherein said fuel tank includes an upper wall, a lower wall, and at least one sidewall extending between said upper and lower walls, and said fuel additive delivery unit is integrally formed with said at least one sidewall.

7. The fuel additive delivery system of claim 1, wherein said fuel additive delivery unit extends upwardly from a lower wall of said fuel tank into said interior volume.

8. The fuel additive delivery system of claim 7, wherein a panel is attached to said lower wall to enclose said fuel additive delivery unit with said fuel additive positioned therewithin.

9. A fuel additive delivery system comprising:
a fuel tank having an upper wall, a lower wall, a plurality of sidewalls extending between said upper and lower walls, and a spout defining an opening extending from said upper wall, said fuel tank defining and interior volume; and
a fuel additive delivery unit integrally connected with said lower wall or one of said sidewalls of said fuel tank, wherein a fuel additive is located within said fuel additive delivery unit being in continual fluid communication with fuel in said fuel tank.

10. The fuel additive delivery system of claim 9, wherein said fuel additive delivery unit includes a raised portion extending into said interior volume from said lower wall, said raised portion having at least one aperture formed therethrough to allow fuel within said interior volume to enter said fuel additive delivery unit to intermix with said fuel additive.

11. The fuel additive delivery system of claim 10, wherein said fuel additive delivery unit further includes a panel attached to said lower wall of said fuel tank to enclose said fuel additive delivery unit.

12. The fuel additive delivery system of claim 11, wherein said panel is fixedly attached to said lower wall.

13. The fuel additive delivery system of claim 11, wherein said panel is releasably attached to said lower wall.

14. The fuel additive delivery unit of claim 9, wherein said fuel additive delivery unit is formed around said fuel additive.
